(19) United States
(12) Patent Application Publication
(10) Pub. No.: US 2023/0176221 A1
(43) Pub. Date: Jun. 8, 2023

(54) LIDAR SYSTEM WITH REDUCED PARALLAX, DISTORTION, AND DEFOCUS ISSUES

(71) Applicant: Continental Autonomous Mobility US, LLC, Auburn Hills, MI (US)

(72) Inventor: Horst W Wagner, Goleta, CA (US)

(73) Assignee: Continental Autonomous Mobility US, LLC, Auburn Hills, MI (US)

(21) Appl. No.: 17/938,436

(22) Filed: Oct. 6, 2022

Related U.S. Application Data
(60) Provisional application No. 63/262,153, filed on Oct. 6, 2021.

(51) Int. Cl. G01S 17/89; G01S 7/4863; G01S 7/4865

(52) U.S. Cl. CPC G01S 17/89; G01S 7/4863; G01S 7/4865

(57) ABSTRACT

A lidar system includes a laser configured to generate a light pulse and transmit optics configured to receive the light pulse and direct toward an external environment. Receive optics, separate from the transmit optics, are configured to receive light from the light pulse reflected off of an object in the external environment. An array of photodetectors is positioned to receive the light from the receive optics and generate an image corresponding to an instantaneous field of view (“iFOV”) of the external environment. Aa controller is configured to adjust the iFOV as a function of a time of flight of the light pulse generated by the laser.

### CROSS-REFERENCE TO RELATED APPLICATIONS

This application claims priority to provisional application No. 63/262,153, filed on Oct. 6, 2021, which is hereby incorporated by reference.

### TECHNICAL FIELD

The technical field relates generally to lidar sensors.

### BACKGROUND

Lidar systems measure the time of flight (indirect or direct) of light to measure the distance to objects. For time of flight measurement, light is emitted along a transmission path through transmission optics and received along a receiving path via receive optics. In many lidar systems, transmission and receiving paths use separate optics and there is an offset between the transmission and receiving optical axis. Consequently, the projection of reflected light from a target will move on a focal plane of a receive sensor depending on distance. This effect is known as parallax and illustrated in FIG. 1.

If a light beam were projected at a fixed angle onto a wall (or large object) orthogonal to the optical axis then the beam spot will move on the focal plane as shown in the example of FIG. 2.

For a conventional scanning system, the transmission illumination is steered as a beam across the field of view. The receiver in a scanning system could either have some type of scanning optics or, as an alternative approach, use a so-called staring array. The staring array is a regular fix mounted, arrayed imager which observes the complete field of view.

In principle, one could simply sum the response of all pixels as the receive signal and some systems simply have a photodetector (single pixel) observing the complete field of view.

For a staring array it is beneficial to limit the observation area to the smaller field of view where the reflected light is expected. Otherwise, signal from ambient light sources or noise from pixels will be unnecessarily collected and degrade the signal quality.

This solid angle over which light is collected for a single scan point can be called the instantaneous field of view (“iFOV”). The iFOV must be large enough to accommodate both the beam profile as well as shift due to parallax. The iFOV can be updated with every scan point.

As an example, the iFOV can be configured by a predefined set of pixels as shown in FIG. 3. The set of pixels is updated with each scan point. This is state of the art.

For some emerging technologies (e.g. wafer on wafer stacked SPAD) it is possible to build and individually read-out pixels of very small width, e.g. 5 μm to 10 μm, and sometimes referred to as micropixel. Micropixels usually end up being much smaller than the projected beam spot on the focal plane. Individual read-out of each micropixel can create a massive burden to the design due to the sheer count.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram of a lidar system illustrating the parallax effect;

FIG. 2 illustrates a light beam projected onto an object at various distances;

FIG. 3 illustrates an instantaneous field of view (“iFOV”) made up of a predefined set of pixels;

FIG. 4 illustrates bundled micropixels in an array scanner system;

FIG. 5 illustrates the bundled micropixels of FIG. 4 at various times;

FIG. 6 is a schematic diagram of a lidar system with digital receiver technology according to one exemplary embodiment;

FIG. 7 is a schematic diagram of a lidar system with analog receiver technology according to one exemplary embodiment;

FIG. 8 illustrates micropixels and the iFOV at a center of a field of view and a corner of the field of view; and

FIG. 9 illustrates micropixels and the iFOV with a large time of flight and a short time of flight.

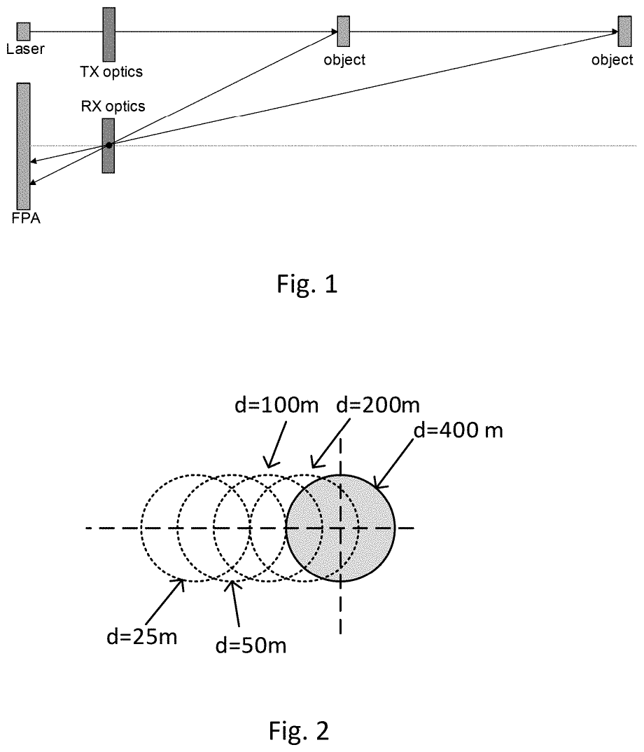

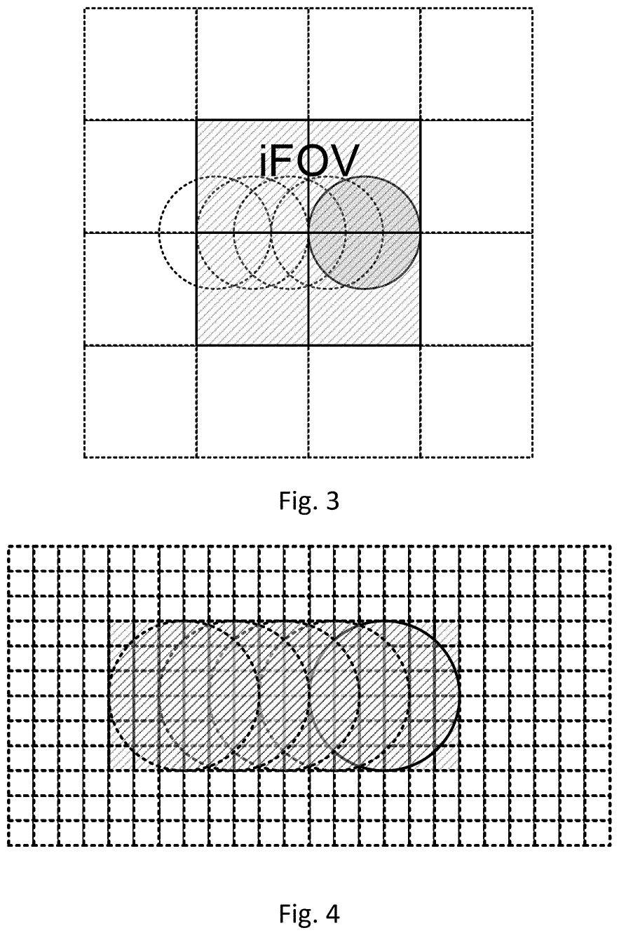

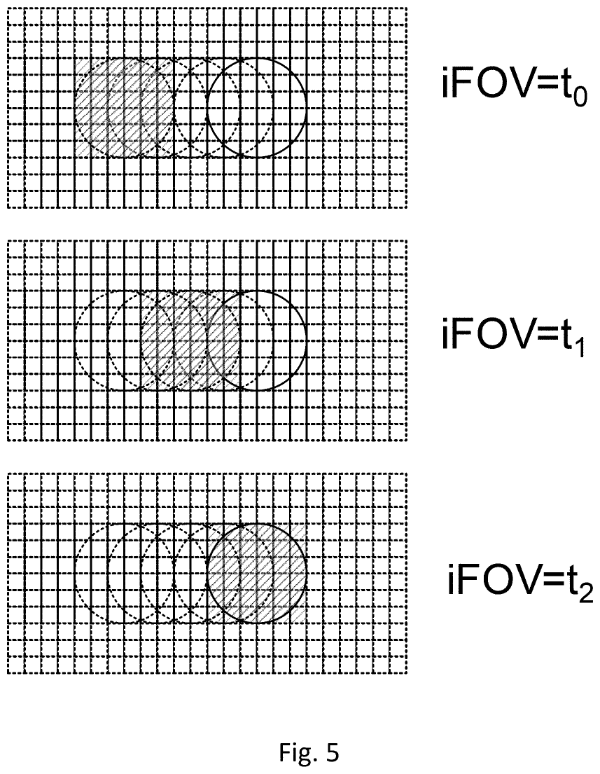

### DETAILED DESCRIPTION

One possible approach is to bundle a certain number of micropixels (e.g., a 5×5 array) to represent a “regular” pixel. Another approach that can be used in a staring array scanner system is to bundle the micropixels to achieve a more targeted iFOV as shown in FIG. 4.

The proposed lidar sensor adjusts the instantaneous field of view as a function of the time of flight. Just after the laser fires we know that any object creating a reflection of light is close to the lidar sensor and have a very large parallax. As such the instantaneous field of view may be optimized to account for the large parallax. As time progresses, any reflections received by the receiver optics must have originated by more distant objects and the iFOV can be adjusted to reflect a smaller parallax.

Given the constant speed of light and that the parallax can be precisely calculated/simulated, the optimal iFOV is a very deterministic function of time of flight and independent of object type, object properties, etc.

The optimal iFOV can be predetermined, e.g., by calculation or by calibration at final product test and this information stored in the camera. Alternatively, the geometric properties can be stored in the camera and the optimal iFOV calculated within the camera on-the-fly.

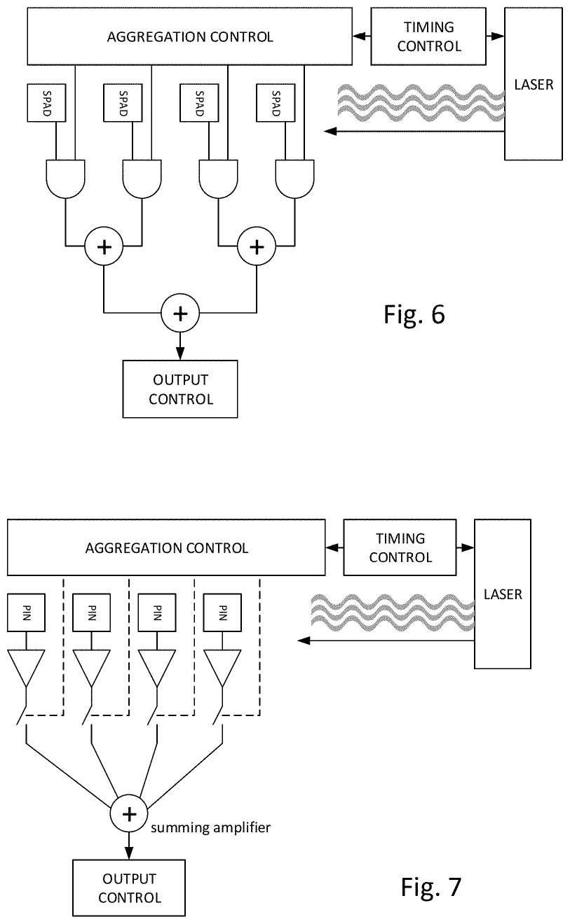

The proposed lidar system can both be implemented for a digital (e.g., SPAD) or an analog receiver technology (e.g., PIN). FIGS. 6 and 7 illustrate how an implementation could be achieved in both cases. Since summation in the digital domain is lossless, application is easier for a digital receiver technology. For an analog receiver the summation needs to be optimized to minimize injected noise. Also benefits of a reduced iFOV needs to be weighed against the increase in noise due to the dynamic analog summation.

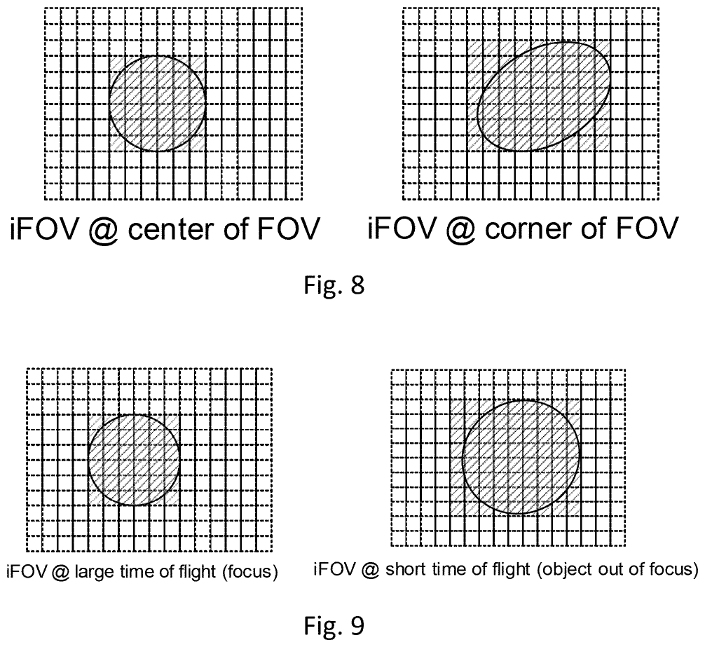

Finally, FIG. 8 and FIG. 9, show a possible extension of the described concepts.

A practical lens system will always lead to distortion. Whereas an ideal optical system will project a circle as a circle on the focal plane, a realistic optical system will project this e.g. as an ellipsis or possibly as a complex shape due to astigmatism. In addition, not only the shape but also the position of the projected image on the focal plan can be shifted from the expected location due to lens distortion.

Accounting for the shift of the expected location may be achieved by finding the optimal location on the focal plane of a 2×2 pixel iFOV during end of line calibration. However, the shape and size of 2×2 pixel iFOV are independent of the scan point location and time of flight.

With a smaller pixel geometry there could be a considerable advantage of accounting for distortion by allowing in addition shape and size (not only location) of the iFOV to be a function of scan location (see FIG. 8).

Furthermore, distortion due to parallax and defocusing could also be accounted for by including time of flight. Lidar sensors typically utilize fixed focus lenses focused on large distances. The increase in blur for nearby objects due to defocusing could again be addressed by a time of flight dependency of the iFOV. (see FIG. 9)

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within.

What is claimed is:

1. A lidar system, comprising:
a laser configured to generate a light pulse;
transmit optics configured to receive the light pulse from said laser and direct the light pulse toward an external environment;
receive optics separate from said transmit optics for receiving light from the light pulse reflected off of an object in the external environment;
an array of photodetectors positioned to receive the light from the receive optics and generate an image corresponding to an instantaneous field of view (“iFOV”) of the external environment;
a controller configured to adjust the iFOV as a function of a time of flight of the light pulse generated by said laser.

2. The lidar system as set forth in claim 1, wherein at least one of said photodetectors is a single-photon avalanche diode.

3. The lidar system as set forth in claim 1, wherein at least one of said photodetectors is a PIN photodiode.
